(19) United States
(12) Patent Application Publication
(10) Pub. No.: US 2014/0050170 A1
(43) Pub. Date: Feb. 20, 2014

(54) METHOD FOR CONTROLLING OPERATIONAL STATUS AND TERMINAL EQUIPMENT

(71) Applicant: FUJITSU LIMITED, Kawasaki-shi (JP)

(72) Inventors: Haibo XU, Beijing (CN); Yanling LU, Beijing (CN)

(73) Assignee: FUJITSU LIMITED, Kawasaki-shi (JP)

(21) Appl. No.: 14/061,213

(22) Filed: Oct. 23, 2013

Related U.S. Application Data
(63) Continuation of application No. PCT/CN2011/073435, filed on Apr. 28, 2011.

(51) Int. Cl. H04W 8/22; H04W 88/06

(52) U.S. Cl. CPC H04W 8/22; H04W 88/06
USPC 370/329

(57) ABSTRACT

Embodiments of the present invention provide a method for controlling an operational status and terminal equipment. The method comprises: judging by terminal equipment whether a scheduling request procedure or a random access procedure initiated to a base station is finished, when on duration is terminated and an inactivity timer is overtime, or a DRX command transmitted by a base station is received; and keeping in an LTE operational status by the terminal equipment instead of entering into an ISM operational status when it is judged that the scheduling request procedure or the random access procedure is not finished. In the embodiments of the present invention, the waste of the resources of the LTE system may be lowered and the performance of the LTE system may be improved.

### CROSS-REFERENCE TO RELATED APPLICATIONS

This application is a continuation of International Application PCT/CN2011/073435, filed on Apr. 28, 2011 and designating the U.S., the entire contents of which are incorporated herein by reference.

### TECHNICAL FIELD

The present invention relates to the field of communications and, in particular to a method for controlling an operational status and terminal equipment.

### BACKGROUND ART

In order to achieve access of users everywhere, terminal equipment needs to be equipped with multiple sets of transceivers for accessing various networks. For example, the terminal equipment may be simultaneously equipped with transceivers of a long-term evolution (LTE) system and an industrial scientific medical (ISM) system (such as WiFi, and Bluetooth, etc.), etc. As multiple sets of transceivers in the same terminal equipment are very close to one another, the power of a transmitter of a system may be much higher than that of a receiver of another system.

FIG. 1 gives an example of interference coexistence. As shown in FIG. 1, the terminal equipment may comprise an LTE system, a GPS system and a Bluetooth/WiFi system, wherein the LTE system may bring interference to the Bluetooth/WiFi system, and the Bluetooth/WiFi system may also bring interference to the LTE system. If the operational frequency bands of different systems are spaced apart relatively far, the interference brought by the transmitted signals to the received signals may be well controlled by filtering technologies.

However, for some scenarios, for example, when the operational frequency bands of different systems in the same terminal equipment are proximal to one another, the existing filtering technologies are insufficient to provide efficient interference avoidance. Therefore, for such scenarios, besides the filtering technologies, other methods need to be taken into consideration, so as to achieve interference avoidance in case of coexistence of multiple system transceivers in terminal equipment.

Currently, following scenarios of system coexistence are mainly taken into consideration in 3GPP:

(1) coexistence of an LTE system and a WiFi system;

(2) coexistence of an LTE system and a Bluetooth system; and

(3) coexistence of an LTE system and a Global Navigation Satellite System (GNSS).

And problems of interference that will occur in the above scenarios of system coexistence comprise:

(1) at Band 40 of an LTE system, the transmission of signals of the LTE system will bring interference to the reception of the signals of an ISM system;

(2) at Band 40 of an LTE system, the transmission of signals of an ISM system will bring interference to the reception of the signals of the LTE system;

(3) at Band 7 of an LTE system, the transmission of signals of the LTE system will bring interference to the reception of the signals of an ISM system; and

(4) at Band 7/13/14 of an LTE system, the transmission of signals of the LTE system will bring interference to the reception of the signals of a GNSS system.

In order to avoid the coexistence interference in the above scenarios, one of the methods uses a manner of time-division multiplexing, wherein signal transmission and signal reception of two different systems are temporally spaced apart. FIG. 2 is a schematic diagram of an example of terminal equipment in receiving LTE system signals and transmitting WiFi or Bluetooth signals at different moments.

Currently, two methods of achieving time-division multiplexing are defined in 3GPP, comprising:

(1) a method of reservation based on a hybrid automatic repeat request (HARQ) procedure. In this method, a part of subframes are reserved for an LTE system according to a time relation of the HARQ procedure defined by the LTE system, and the rest of the subframes are allocated to an ISM system; that is, the terminal equipment may perform transmission and reception of the data of the ISM system in the rest of the subframes; and

(2) a method of discontinued receive (DRX) based on an LTE system. In this method, the DRX mechanism of the current LTE system is used, and after the LTE transceiver of the terminal equipment enters into a sleeping state, the terminal equipment may perform transmission and reception of the data of an ISM system.

In order to carry out the method, the terminal equipment needs to transmit to a base station desired operational cycles of the LTE system and the ISM system, the operational time (hereinafter referred to as TDM patterns) of the LTE system and the ISM system in these cycles, and other auxiliary information, such as a type of interference, and a mode of coexistence, etc. And then the base station determines finally a TDM pattern of coexistence of the LTE system and the ISM system, and realizes the TDM pattern by appropriately configuring DRX parameters. FIG. 3 illustrates a TDM pattern suggested by the terminal equipment to the base station, and FIG. 4 illustrates the configuration of DRX finally determined by a base station according to the suggested TDX pattern.

However, in the implementation of the present invention, the inventors found following defect exists in the relevant art: in case of coexistence of LTE and ISM, before the terminal equipment terminates the LTE time and starts the ISM time, the terminal equipment initiates a scheduling request or a random access procedure. When the terminal equipment terminates the LTE time and starts the ISM time, the scheduling request/random access procedure have not been finished; at this moment, the terminal equipment enters into the ISM operational status and needs to stop the unfinished scheduling request and random access procedure, so as to avoid mutual interference between the LTE system and the ISM system; and needs to reinitiate the procedure after the ISM operational time is terminated. This will result in waste of resources of the LTE system, affecting the performance of the LTE system.

It should be noted that the above description of the background art is merely provided for clear and complete explanation of the present invention and for easy understanding by those skilled in the art. And it should not be understood that the above technical solution is known to those skilled in the art as it is described in the background art of the present invention.

### SUMMARY OF THE INVENTION

Embodiments of the present invention provide a method for controlling an operational status and terminal equipment, with an object being that the terminal equipment does not enter into an ISM operational status, when LTE time is terminated and ISM time is started and a scheduling request procedure or a random access procedure is not finished.

According to an aspect of the embodiments of the present invention, there is provided a method for controlling an operational status, comprising:

a procedure judgment process for judging, by terminal equipment, whether a scheduling request procedure or a random access procedure initiated to a base station is finished, when on duration of a DRX mechanism of an LTE system ends and an inactivity timer is overtime, or a DRX command transmitted by the base station is received; and

a status controlling process for keeping in an LTE operational status by the terminal equipment instead of entering into an ISM operational status, when it is judged in the procedure judgment process that the scheduling request procedure or the random access procedure is not finished.

According to another aspect of the embodiments of the present invention, there is provided terminal equipment, comprising:

a procedure judger, configured to judge whether a scheduling request procedure or a random access procedure initiated to a base station is finished when on duration of a DRX mechanism of an LTE system ends and an inactivity timer is overtime, or a DRX command transmitted by the base station is received; and

a status controller, configured to keep the terminal equipment in an LTE operational status instead of entering into an ISM operational status when it is judged by the procedure judger that the scheduling request procedure or the random access procedure is not finished.

According to still another aspect of the embodiments of the present invention, there is provided a computer-readable program, wherein when the program is executed in terminal equipment, the program enables the computer to carry out the method for controlling an operational status as described above in the terminal equipment.

According to further still another aspect of the embodiments of the present invention, there is provided a storage medium in which a computer-readable program is stored, wherein the computer-readable program enables the computer to carry out the method for controlling an operational status as described above in terminal equipment.

The advantages of the embodiments of the present invention exist in: terminal equipment judges whether a scheduling request procedure or a random access procedure is finished, when an LTE operational time ends and an inactivity timer is overtime, or a DRX command transmitted by a base station is received; keeps in an LTE operational status instead of entering into an ISM operational status when it is not finished; such that waste of resources of the LTE system may be lowered, and the performance of the LTE system may be improved.

With reference to the following description and drawings, the particular embodiments of the present invention are disclosed in detail, and the principle of the present invention and the manners of use are indicated. It should be understood that the scope of the embodiments of the present invention is not limited thereto. The embodiments of the present invention contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the present invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be enlarged or reduced.

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

FIG. 1 is an example of interference coexistence in the relevant art;

FIG. 2 is a schematic diagram of an example of terminal equipment in receiving LTE system signals and transmitting WiFi or Bluetooth signals at different moments;

FIG. 3 is a schematic diagram of a TDM pattern suggested by terminal equipment to a base station in the relevant art;

FIG. 4 is a schematic diagram of the configuration of DRX finally determined by the base station according to the TDX pattern of FIG. 3;

FIG. 5 is a schematic diagram of controlling terminal equipment to enter into an ISM operational status from an LTE operational status by on duration;

FIG. 6 is a schematic diagram of controlling the terminal equipment to enter into an ISM operational status from an LTE operational status by an inactivity timer;

FIG. 7 is a schematic diagram of controlling the terminal equipment to enter into an ISM operational status from an LTE operational status by a DRX command;

FIG. 8 is a flowchart of the method for controlling an operational status of an embodiment of the present invention;

FIG. 9 is another flowchart of the method for controlling an operational status of an embodiment of the present invention;

FIG. 10 is still another flowchart of the method for controlling an operational status of an embodiment of the present invention;

FIG. 11 is a schematic diagram of the composition of the terminal equipment of an embodiment of the present invention;

FIG. 12 is another schematic diagram of the composition of the terminal equipment of an embodiment of the present invention;

FIG. 13 is a schematic diagram of the composition of a procedure judger of an embodiment of the present invention; and

FIG. 14 is a diagram of the systematic structure of the terminal equipment of an embodiment of the present invention.

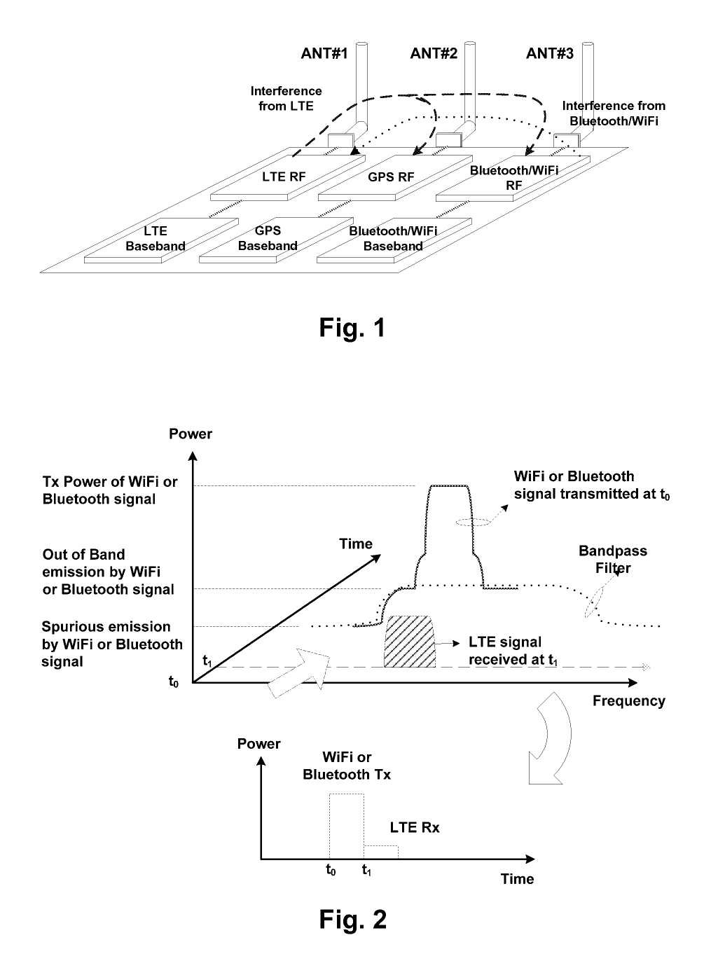

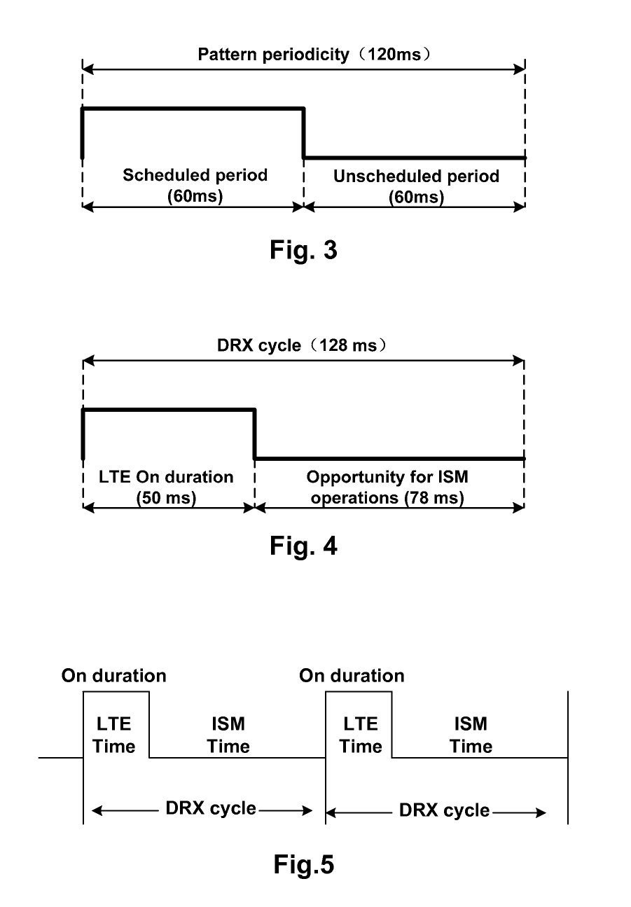

### DETAILED DESCRIPTION OF THE INVENTION

The foregoing and other features of the embodiments of the present invention will become apparent with reference to the drawings and the following description. In the description and drawings, particular embodiments of the present invention are disclosed, which show some embodiments in which the principle of the present invention may be employed. It should be understood that the present invention is not limited to the described embodiments, on the contrary, the present invention includes all the modifications, variants and the equivalents thereof falling within the scope of the appending claims.

In order to control terminal equipment to enter into an ISM operational status from an LTE operational status, three methods have currently been given according to the DRX mechanism of LTE. Refer to R2-106399, “Potential mechanism to realize TDM pattern”, Huawei, HiSilicon, for details.

FIG. 5 is a schematic diagram of controlling the terminal equipment to enter into an ISM operational status from an LTE operational status by on duration of the DRX mechanism of an LTE system. As shown in FIG. 5, after the on duration is terminated, the terminal equipment stops the LTE operational status and enters into the ISM operational status.

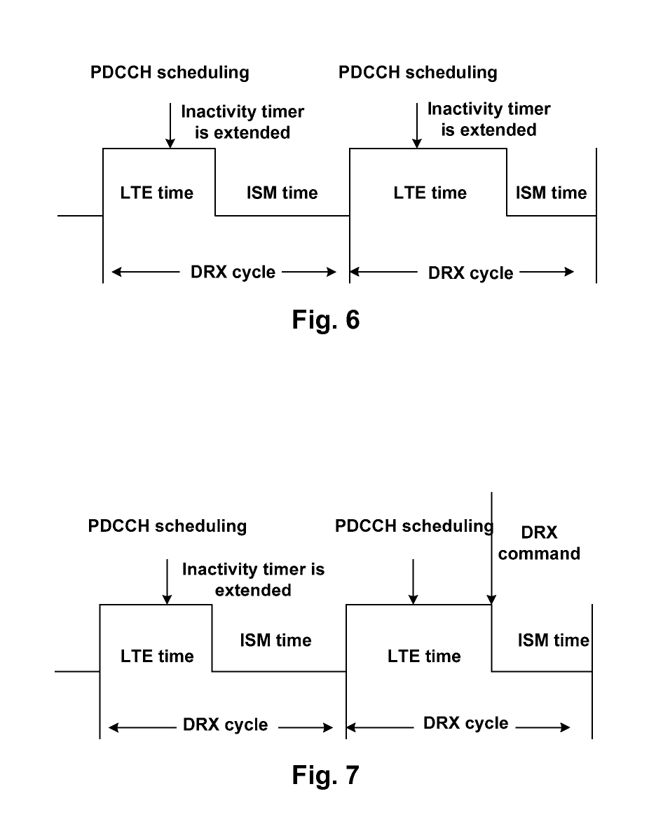

FIG. 6 is a schematic diagram of controlling the terminal equipment to enter into an ISM operational status from an LTE operational status by an inactivity timer. As shown in FIG. 6, after the inactivity timer is overtime, the terminal equipment stops the LTE operational status and enters into the ISM operational status.

As shown in FIG. 6, after receiving a resource of physical downlink control channel (PDCCH) transmitted by a base station, the terminal equipment may start or restart the inactivity timer; and if the inactivity timer is not overtime, the terminal equipment does not enter into the ISM operational status.

FIG. 7 is a schematic diagram of controlling the terminal equipment to enter into an ISM operational status from an LTE operational status by a discontinued receive (DRX) command. As shown in FIG. 7, the terminal equipment is controlled by the received DRX command, that is, the base station transmits a DRX command to control the terminal equipment to enter into the ISM operational status from the LTE operational status.

However, following defect exists in the above method: the terminal equipment enters into the ISM operational status immediately after the on duration is terminated and the inactivity timer is overtime, or the DRX command is received, thereby needing to stop an unfinished scheduling request or random access procedure, and resulting in waste of resource of the LTE system.

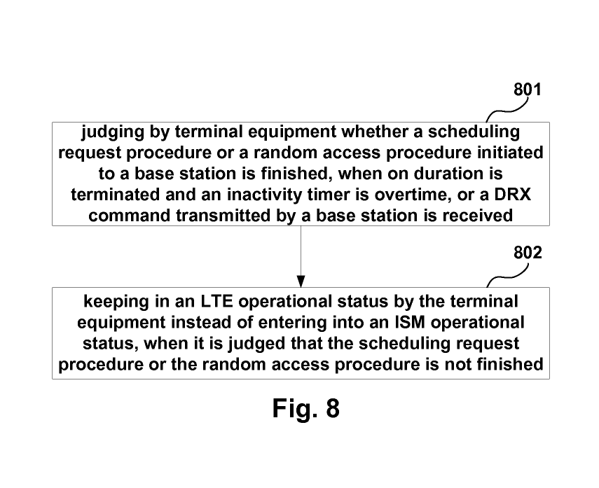

An embodiment of the present invention provides a method for controlling an operational status. As shown in FIG. 8, the method comprises:

step 801: judging, by terminal equipment, whether a scheduling request procedure or a random access procedure initiated to a base station is finished, when on duration is terminated and an inactivity timer is overtime, or a DRX command transmitted by a base station is received; and

step 802: keeping in an LTE operational status by the terminal equipment instead of entering into an ISM operational status, when it is judged in step 801 that the scheduling request procedure or the random access procedure is not finished.

In an embodiment, before step 801, the terminal equipment has transmitted the scheduling request in a physical uplink control channel (PUCCH), and whether the scheduling request procedure is finished may be judged particularly in step 801.

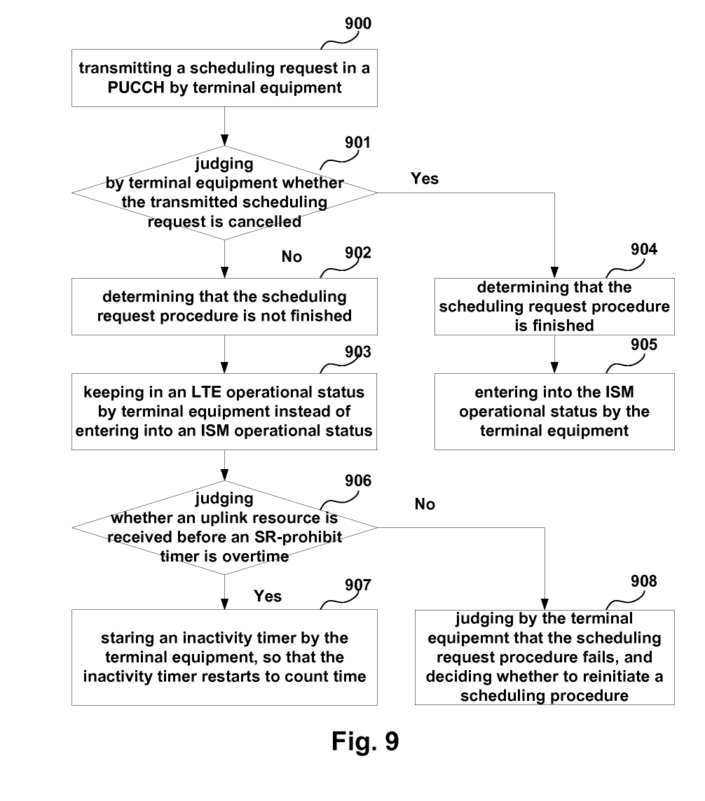

FIG. 9 is another flowchart of the method for controlling an operational status of an embodiment of the present invention. As shown in FIG. 9, the method comprises:

step 900: transmitting a scheduling request in a PUCCH by terminal equipment;

as shown in FIG. 9, the terminal equipment executes the following steps when on duration is terminated and an inactivity timer is overtime, or a DRX command transmitted by a base station is received:

step 901: judging, by the terminal equipment, whether the transmitted scheduling request is cancelled; executing step 902 if the scheduling request is not cancelled; and executing step 904 if the scheduling request is cancelled;

step 902: determining that the scheduling request procedure is not finished;

step 903: keeping in an LTE operational status by the terminal equipment instead of entering into an ISM operational status;

step 904: determining that the scheduling request procedure is finished;

step 905: entering into the ISM operational status by the terminal equipment.

As shown in FIG. 9, after step 903, the method may further comprise:

step 906: monitoring, by the terminal equipment, a PDCCH, and judging whether a scheduling request prohibit timer (SR-prohibit timer) is overtime;

In this embodiment, if before the SR-prohibit timer is overtime, the terminal equipment receives uplink resources transmitted by the base station in the PDCCH according to the scheduling request, the method may further comprise:

step 907: staring an inactivity timer by the terminal equipment, so that the inactivity timer restarts to count time.

After the inactivity timer restarts to count time and before it is overtime, the terminal equipment may still in the LTE operational status. And after the inactivity timer is overtime, the terminal equipment may enter into the ISM operational status.

In this embodiment, if the terminal equipment does not receive the uplink resources transmitted by the base station in the PDCCH according to the scheduling request until the SR-prohibit timer is overtime, the method may further comprise:

step 908: judging, by the terminal equipment, that the scheduling request procedure fails, and deciding by itself whether to reinitiate a scheduling procedure.

In this embodiment, if the terminal equipment decides to stop transmitting the scheduling procedure, it may enter into the ISM system operational status; and if the terminal equipment decides to reinitiate the scheduling procedure, it may transmit a scheduling request in the PUCCH, keep in the LTE operational status, and monitor the PDCCH.

In another embodiment, before step 801, the terminal equipment has transmitted preamble information in a physical random access channel (PRACH), and whether a random access procedure is finished may be judged particularly in step 801.

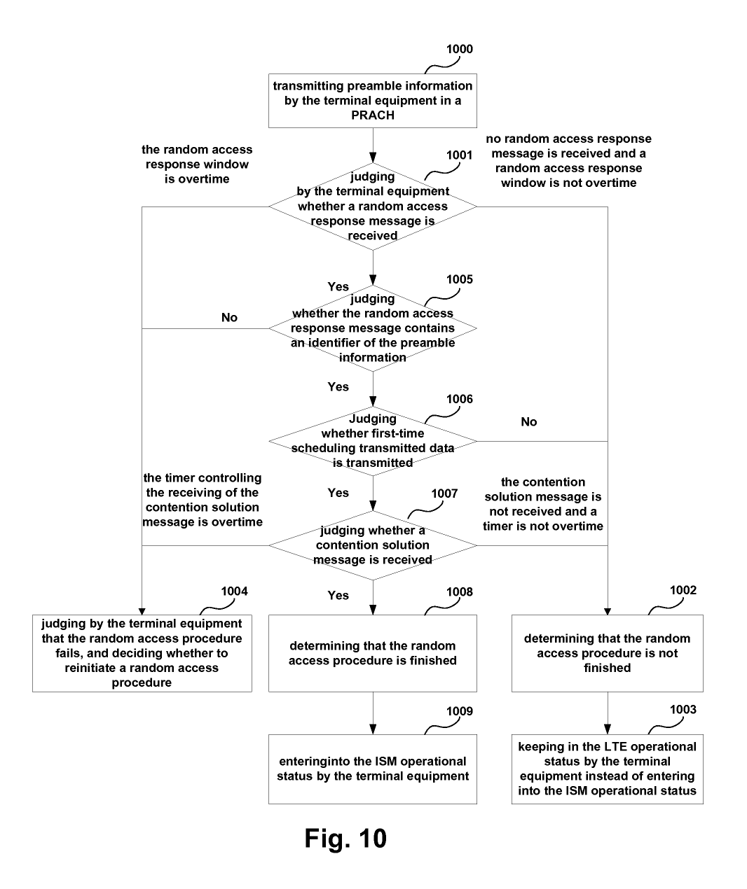

FIG. 10 is still another flowchart of the method for controlling an operational status of an embodiment of the present invention. As shown in FIG. 10, the method comprises:

step 1000: transmitting preamble information by the terminal equipment in a PRACH.

As shown in FIG. 10, the terminal equipment executes the following steps when the on duration is terminated and the inactivity timer is overtime, or a DRX command transmitted by the base station is received:

step 1001: judging, by the terminal equipment, whether a random access response message is received, and executing step 1002 if no random access response message is received and a random access response window is not overtime;

step 1002: determining, by the terminal equipment, that the random access procedure is not finished;

step 1003: keeping in the LTE operational status by the terminal equipment instead of entering into the ISM operational status.

In this embodiment, as shown in FIG. 10, if the random access response window is overtime, the method may further comprise:

step 1004: judging, by the terminal equipment, that the random access procedure fails, and deciding whether to reinitiate a random access procedure.

In this embodiment, if the terminal equipment decides to reinitiate a random access procedure, the terminal equipment transmits preamble information in the PRACH and keeps in the LTE operational status after a backoff time is terminated; and if the terminal equipment decides to stop reinitiating a random access procedure, the terminal equipment directly enters into the ISM operational status.

As shown in FIG. 10, receiving the random access response message is judged in step 1001, and the method may further comprise:

step 1005: judging whether the random access response message contains an identifier of the preamble information, and executing step 1006 if the random access response message contains an identifier of the preamble information; otherwise, executing step 1004.

As shown in FIG. 10, after receiving the random access response message and if the random access response message contains an identifier of the preamble information, the method may further comprise:

step 1006: judging, by the terminal equipment, whether first-time scheduling transmitted data, i.e. Message 3, is transmitted; and executing step 1002 if the first-time scheduling transmitted data is not transmitted, so as to determine that the random access procedure is not finished;

As shown in FIG. 10, if it is judged in step 1006 that the first-time scheduling transmitted data is transmitted, the method may further comprise:

step 1007: judging, by the terminal equipment, whether a contention solution message is received; executing step 1002 if the contention solution message is not received and a timer controlling the receiving of the contention solution message is not overtime, so as to determine that the random access procedure is not finished; and executing step 1008 if the contention solution message is received;

step 1008: determining that the random access procedure is finished; and

step 1009: entering into the ISM operational status by the terminal equipment.

In this embodiment, as shown in FIG. 10, if the timer controlling the receiving of the contention solution message is overtime, the terminal equipment may execute step 1004, judge that the random access procedure fails, and decide whether to reinitiate a random access procedure.

If the terminal equipment decides to reinitiate a random access procedure, it transmits the preamble information in the PRACH and keeps in the LTE operational status after the backoff time is terminated; and if the terminal equipment decides to stop reinitiating a random access procedure, it directly enters into the ISM operational status.

It can be seen from the above embodiment that: the terminal equipment judges whether a scheduling request procedure or a random access procedure is finished, after the on duration is terminated and the inactivity timer is overtime, or a DRX command transmitted by the base station is received; it keeps in the LTE operational status instead of entering into an ISM operational status if the procedure is not finished; such that the waste of the resources of the LTE system may be lowered and the performance of the LTE system may be improved.

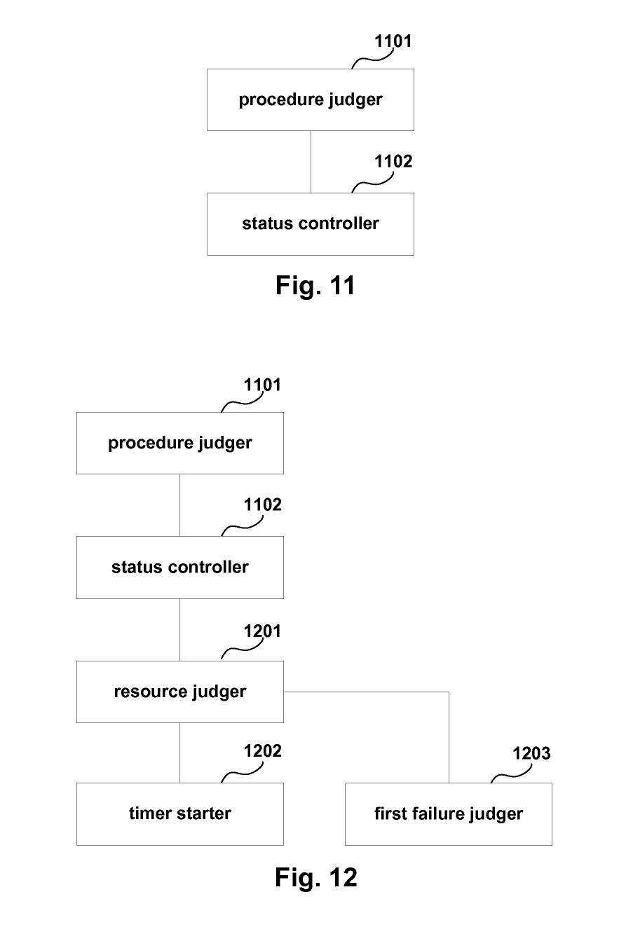

An embodiment of the present invention further provides terminal equipment. As shown in FIG. 11, the terminal equipment comprises a procedure judger 1101 and a status controller 1102; wherein,

the procedure judger 1101 is configured to judge whether a scheduling request procedure or a random access procedure initiated to a base station is finished when on duration is terminated and an inactivity timer is overtime, or a DRX command transmitted by the base station is received; and

the status controller 1102 is configured to control the terminal equipment to keep in an LTE operational status instead of entering into an ISM operational status, when it is judged by the procedure judger 1101 that the scheduling request procedure or the random access procedure is not finished.

In an embodiment, the terminal equipment transmits a scheduling request in a PUCCH. FIG. 12 is another schematic diagram of the composition of the terminal equipment of an embodiment of the present invention. As shown in FIG. 12, the terminal equipment comprises a procedure judger 1101 and a status controller 1102, as described above.

In this embodiment, the procedure judger 1101 may comprise:

a request judger configured to judge whether the scheduling request is cancelled; and

a request determiner configured to determine that the scheduling request procedure is not finished if the scheduling request is not cancelled.

As shown in FIG. 12, the terminal equipment may further comprise: a resource judger 1201 and a timer starter 1202; wherein,

the resource judger 1201 is configured to judge whether the uplink resource transmitted by the base station in the PDCCH according to the scheduling request is received before a SR-prohibit timer is overtime; and

the timer starter 1202 is configured to start the inactivity timer if the uplink resource transmitted by the base station in the PDCCH according to the scheduling request is received before the SR-prohibit timer is overtime, such that the inactivity timer restarts to count time.

As shown in FIG. 12, the terminal equipment may further comprise: a first failure judger 1203;

The first failure judger 1203 is configured to judge that the scheduling request procedure fails and determine whether proceeding to initiate a scheduling request procedure, if no uplink resource transmitted by the base station in the physical downlink control channel according to the scheduling request is received until the SR-prohibit timer is overtime.

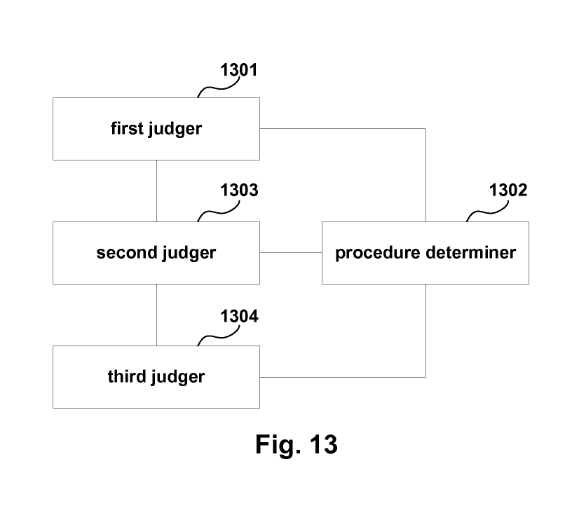

In another embodiment, the terminal equipment transmits preamble information in a PRACH, and the terminal equipment comprises a procedure judger 1101 and a status controller 1102, as described above. FIG. 13 is a schematic diagram of the composition of the procedure judger 1101.

As shown in FIG. 13, the procedure judger 1101 may comprise: a first judger 1301 and a procedure determiner 1302; wherein,

The first judger 1301 is configured to judge whether a random access response message is received; and

The procedure determiner 1302 is configured to determine that the random access procedure is not finished, if it is judged by the first judger 1301 that no random access response message is received and a random access response window is not overtime.

Furthermore, as shown in FIG. 13, the procedure judger 1101 may further comprise: a second judger 1303; wherein,

the second judger 1303 is configured to judge whether first-time scheduling transmitted data is transmitted, if it is judged by the first judger 1301 that the random access response message is received and the random access response message contains an identifier of the preamble information;

and the procedure determiner 1302 is further configured to determine that the random access procedure is not finished, if it is judged by the second judger 1303 that the first-time scheduling transmitted data is not transmitted.

Furthermore, as shown in FIG. 13, the procedure judger 1101 may further comprise: a third judger 1304; wherein,

the third judger 1304 is configured to judge whether a contention resolution message is received, when it is judged by the second judger 1303 that the first-time scheduling transmitted data is transmitted;

and the procedure determiner 1302 is further configured to determine that the random access procedure is not finished, if it is judged by the third judger 1304 that the contention resolution message is not received and the timer controlling the contention resolution message is not overtime.

In an embodiment, the terminal equipment may further comprise a second failure judger (not shown) configured to judge that the random access procedure fails and determines whether proceeding to initiate a random access procedure, if the random access response message is not received until the random access response window is overtime, or the received random access response message contains no an identifier of the preamble information transmitted by the terminal equipment in the PRACH, or the timer controlling the contention resolution message is overtime.

It can be seen from the above embodiment that: the terminal equipment judges whether a scheduling request procedure or a random access procedure is finished, after the on duration is terminated and the inactivity timer is overtime, or a DRX command transmitted by the base station is received; it keeps in the LTE operational status instead of entering into an ISM operational status if the procedure is not finished; such that the waste of the resources of the LTE system may be lowered and the performance of the LTE system may be improved.

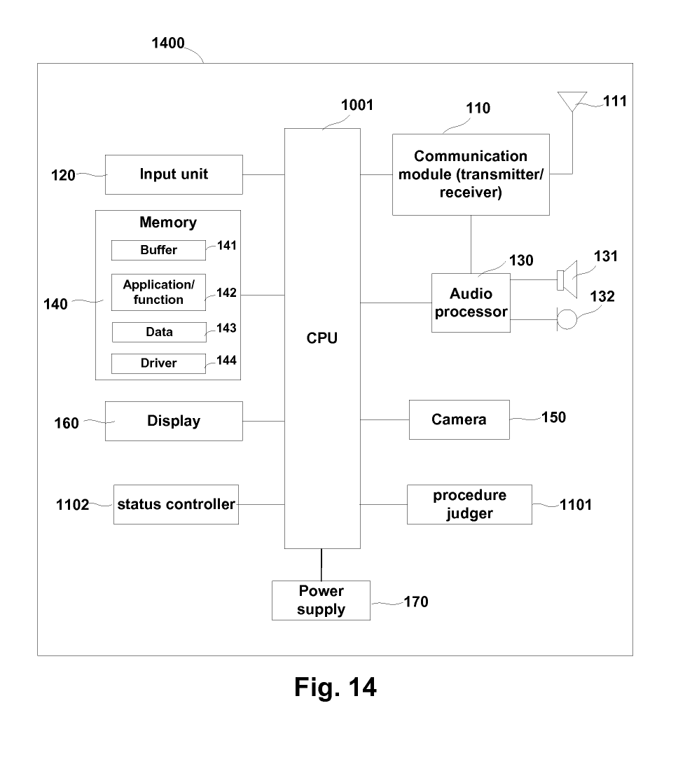

FIG. 14 is a diagram of the systematic structure of the terminal equipment 1400 of an embodiment of the present invention, in which the above-described procedure judger 1101 and status controller 1102 are included. FIG. 14 is illustrative only, and other types of structures may also be used for supplementing or replacing this structure, so as to implement the function of telecommunications or other functions.

As shown in FIG. 14, the terminal equipment 1400 may further comprise a CPU 1001, a communication module 110, an input unit 120, an audio processing unit 130, a memory 140, a camera 150, a display 160, and a power supply 170.

The CPU 1001 (also referred to as a controller or an operational control, which may comprise a microprocessor or other processing devices and/or logic devices) receives input and controls each part and operation of the terminal equipment. The input unit 120 provides input to the CPU 1001. The input unit 120 may be for example a key or touch input device. The camera 150 is used to take image data and provide the taken image data to the CPU 1001 for use in a conventional manner, for example, for storage, and transmission, etc.

The power supply 170 is used to supply power to the terminal equipment. And the display 160 is used to display the objects of display, such as images, and characters, etc. The display may be for example an LCD display, but it is not limited thereto.

The memory 140 is coupled to the CPU 1001. The memory 140 may be a solid memory, such as a read-only memory (ROM), a random access memory (RAM), and a SIM card, etc., and may also be such a memory that stores information when the power is interrupted, may be optionally erased and provided with more data. Examples of such a memory are sometimes referred to as an EPROM, etc. The memory 140 may also be certain other types of devices. The memory 140 comprises a buffer memory 141 (sometimes referred to as a buffer). The memory 140 may comprise an application/function storing portion 142 used to store application programs and function programs, or to execute the flow of the operation of the mobile terminal 1000 by the CPU 1001.

The memory 140 may further comprise a data storing portion 143 used to store data, such as a contact person, digital data, pictures, voices and/or any other data used by the mobile terminal. A driver storing portion 144 of the memory 140 may comprise various types of drivers of the terminal equipment for the communication function and/or for executing other functions (such as application of message transmission, and application of directory, etc.) of the terminal equipment.

The communication module 110 is namely a transmitter/receiver 110 transmitting and receiving signals via an antenna 111. The communication module (transmitter/receiver) 110 is coupled to the CPU 1001 to provide input signals and receive output signals, this being similar to the case in a conventional mobile phone.

A plurality of communication modules 110 may be provided in the same terminal equipment for various communication technologies, such a cellular network module, a Bluetooth module, and/or a wireless local network module, etc. The communication module (transmitter/receiver) 110 is also coupled to a loudspeaker 131 and a microphone 132 via the audio processing unit 130, for providing audio output via the loudspeaker 131 and receiving the audio input from the microphone 132, thereby achieving common telecommunications function. The audio processing unit 130 is further coupled to the CPU 1001, thereby enabling the recording of voices in this device via the microphone 132 and playing the voices stored in this device via the loudspeaker 131.

An embodiment of the present invention further provides a computer-readable program, wherein when the program is executed in terminal equipment, the program enables the computer to carry out the method for controlling an operational status as described above in the terminal equipment.

An embodiment of the present invention further provides a storage medium in which a computer-readable program is stored, wherein the computer-readable program enables the computer to carry out the method for controlling an operational status as described above in terminal equipment.

The above apparatuses and methods of the present invention may be implemented by hardware, or by hardware in combination with software. The present invention relates to such a computer-readable program that when the program is executed by a logic device, the logic device is enabled to carry out the apparatus or components as described above, or to carry out the methods or steps as described above. The present invention also relates to a storage medium for storing the above program, such as a hard disk, a floppy disk, a CD, a DVD, and a flash memory, etc.

The present invention is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

What is claimed is:

1. A method for controlling an operational status, comprising:
a procedure judgment process for judging, by terminal equipment, whether a scheduling request procedure or a random access procedure initiated to a base station is finished, when on duration of a discontinued receive (DRX) mechanism of an LTE system ends and an inactivity timer is overtime, or a DRX command transmitted by the base station is received; and
a status controlling process for keeping in an LTE operational status by the terminal equipment instead of entering into an ISM operational status, when it is judged in the procedure judgment process that the scheduling request procedure or the random access procedure is not finished.

2. The method according to claim 1, wherein the terminal equipment transmits a scheduling request in a physical uplink control channel (PUCCH), and the procedure judgment process comprises:
a request judgment process for judging whether the scheduling request is cancelled; and
a request determining process for determining that the scheduling request procedure is not finished if the scheduling request is not cancelled.

3. The method according to claim 2, wherein the method further comprises:
a resource judgment process for judging, by the terminal equipment, whether an uplink resource transmitted by the base station in a physical downlink control channel (PDCCH) in response to the scheduling request is received before a scheduling request prohibit timer is overtime; and
a timer starting process for starting, by the terminal equipment, the inactivity timer, if the uplink resource transmitted by the base station in the PDCCH in response to the scheduling request is received before the scheduling request prohibit timer is overtime, such that the inactivity timer restarts to count time.

4. The method according to claim 3, wherein if no uplink resource transmitted by the base station in the PDCCH in response to the scheduling request is received until the scheduling request prohibit timer is overtime, the method further comprises:
a first failure judgment process for judging, by the terminal equipment, that the scheduling request procedure fails and determining whether proceeding to initiate a scheduling request procedure.

5. The method according to claim 1, wherein the terminal equipment transmits preamble information in a physical random access channel (PRACH), and the procedure judgment process comprises:
a first judgment process for judging, by the terminal equipment, whether a random access response message is received; and
a procedure determining process for determining that the random access procedure is not finished, if the random access response message is not received and a random access response window is not overtime.

6. The method according to claim 5, wherein the procedure judgment process further comprises:
a second judgment process for judging whether first-time scheduling transmitted data is transmitted, if it is judged in the first judgment process that the random access response message is received and the random access response message contains an identifier of the preamble information; and
determining that the random access procedure is not finished if the first-time scheduling transmitted data is not transmitted.

7. The method according to claim 6, wherein the procedure judgment process further comprises:
a third judgment process for judging whether a contention resolution message is received, when it is judged in the second judgment process that the first-time scheduling transmitted data is transmitted; and
determining that the random access procedure is not finished, if the contention resolution message is not received and the timer controlling the contention resolution message is not overtime.

8. The method according to claim 5, wherein if the random access response message is not received until the random access response window is overtime, or the received random access response message contains no an identifier of the preamble information transmitted by the terminal equipment in the PRACH, or the timer controlling the contention resolution message is overtime, the method further comprises:
a second failure judgment process for judging, by the terminal equipment, that the random access procedure fails and determining whether proceeding to initiate a random access procedure.

9. Terminal equipment, comprising:
a procedure judger, configured to judge whether a scheduling request procedure or a random access procedure initiated to a base station is finished, when on duration of a DRX mechanism of an LTE system ends and an inactivity timer is overtime, or a DRX command transmitted by the base station is received; and
a status controller, configured to control the terminal equipment to keep in an LTE operational status instead of entering into an ISM operational status, when it is judged by the procedure judger that the scheduling request procedure or the random access procedure is not finished.

10. The terminal equipment according to claim 9, wherein the terminal equipment transmits a scheduling request in a PUCCH, and the procedure judger comprises:
a request judger, configured to judge whether the scheduling request is cancelled; and
a request determiner, configured to determine that the scheduling request procedure is not finished if the scheduling request is not cancelled.

11. The terminal equipment according to claim 10, wherein the terminal equipment further comprises:
a resource judger, configured to judge whether an uplink resource transmitted by the base station in a PDCCH in response to the scheduling request is received before a scheduling request prohibit timer is overtime; and
a timer starter, configured to start the inactivity timer if the uplink resource transmitted by the base station in the PDCCH in response to the scheduling request is received before the scheduling request prohibit timer is overtime, such that the inactivity timer restarts to count time.

12. The terminal equipment according to claim 11, wherein the terminal equipment further comprises:
a first failure judger, configured to judge that the scheduling request procedure fails and determine whether proceeding to initiate a scheduling request procedure, if no uplink resource transmitted by the base station in the PDCCH in response to the scheduling request is received until the scheduling request prohibit timer is overtime.

13. The terminal equipment according to claim 9, wherein the terminal equipment transmits preamble information in a PRACH, and the procedure judger comprises:
a first judger, configured to judge whether a random access response message is received; and
a procedure determiner, configured to determine that the random access procedure is not finished, if it is judged by the first judger that no random access response message is received and a random access response window is not overtime.

14. The terminal equipment according to claim 13, wherein the procedure judger further comprises:
a second judger, configured to judge whether first-time scheduling transmitted data is transmitted, if it is judged by the first judger that the random access response message is received and the random access response message contains an identifier of the preamble information;
and the procedure determiner is further configured to determine that the random access procedure is not finished, if it is judged by the second judger that the first-time scheduling transmitted data is not transmitted.

15. The terminal equipment according to claim 14, wherein the procedure judger further comprises:
a third judger, configured to judge whether a contention resolution message is received, when it is judged by the second judger that the first-time scheduling transmitted data is transmitted;
and the procedure determiner is further configured to determine that the random access procedure is not finished, if it is judged by the third judger that the contention resolution message is not received and the timer controlling the contention resolution message is not overtime.

16. The terminal equipment according to claim 13, wherein the terminal equipment further comprises:
a second failure judger, configured to judge that the random access procedure fails and determines whether proceeding to initiate a random access procedure, if the random access response message is not received until the random access response window is overtime, or the received random access response message contains no an identifier of the preamble information transmitted by the terminal equipment in the PRACH, or the timer controlling the contention resolution message is overtime.

17. A computer-readable program, wherein when the program is executed in terminal equipment, the program enables the computer to carry out the method for controlling an operational status as claimed in claim 1 in the terminal equipment.

18. A storage medium in which a computer-readable program is stored, wherein the computer-readable program enables the computer to carry out the method for controlling an operational status as claimed in claim 1 in terminal equipment.
